(19) United States
(12) Patent Application Publication
(10) Pub. No.: US 2016/0063182 A1
(43) Pub. Date: Mar. 3, 2016

(54) MONITORING AND DETECTING ANOMALIES IN HEALTHCARE INFORMATION

(71) Applicant: Verizon Patent and Licensing Inc., Arlington, VA (US)

(72) Inventors: Ashok N. SRIVASTAVA, Mountain View, CA (US); Kalyan PAMARTHY, San Francisco, CA (US)

(21) Appl. No.: 14/472,880

(22) Filed: Aug. 29, 2014

(51) Int. Cl. G06F 19/00

(52) U.S. Cl. CPC G06F 19/32

(57) ABSTRACT

A device receives healthcare information, associated with users, that includes information associated with a health of the users, and information associated with monitoring devices that monitor the health of the users, or information associated with network connectivity of the monitoring devices. The device performs an analysis of the healthcare information via one or more analytics techniques, and generates analysis information based on the analysis of the healthcare information. The analysis information identifies a potential issue with at least one of the users or at least one of the monitoring devices. The device provides the analysis information for display.

### BACKGROUND

Users today utilize a variety of user devices, such as cell phones, smart phones, tablet computers, or the like, to access healthcare information, monitor user vital signs, and/or perform other tasks. Users may also utilize home monitoring systems that include personal monitoring devices (e.g., heart rate monitors, blood pressure monitors, or the like) for monitoring user vital signs.

Healthcare providers, such as doctors, pharmacies, hospitals, nursing homes, or the like, provide a variety of healthcare services to particular users (e.g., patients) and may collect a variety of healthcare information about the users. Furthermore, many healthcare providers maintain a database of electronic health records (EHRs) for their users' healthcare information. The healthcare information may include, for example, discharge summaries when users are discharged from a hospital; reasons for a referral; consultant reports to referring doctors; medication lists; imaging test results; lab results; a care plan from specialists; discharge instructions; a list of follow-up appointments, procedures, tests, and referrals; a medication allergy list; a problem list; vital sign readings from home monitors and/or user devices; or the like.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of a device that may correspond to one or more of the devices of the environment depicted in FIG. 2;

FIG. 4 is a flow chart of an example process for receiving and configuring an analysis application for a user device;

FIGS. 5A and 5B are diagrams of example user interfaces that may be used in connection with the example process shown in FIG. 4;

FIG. 6 is a flow chart of an example process for monitoring and detecting anomalies in healthcare information; and

FIGS. 7A-7G are diagrams of an example relating to the example process shown in FIG. 6.

### DETAILED DESCRIPTION OF PREFERRED EMBODIMENTS

The following detailed description refers to the accompanying drawings. The same reference numbers in different drawings may identify the same or similar elements.

Current healthcare information collection systems are not interconnected and do not provide a single repository for healthcare information associated with users. For example, healthcare information, for a particular user, collected by a user device is not associated with healthcare information collected by hospitals, home monitoring systems, pharmacies, or the like. Furthermore, most healthcare information about users is collected using high-cost personal monitoring equipment at hospitals, in homes, at doctors' offices, or the like.

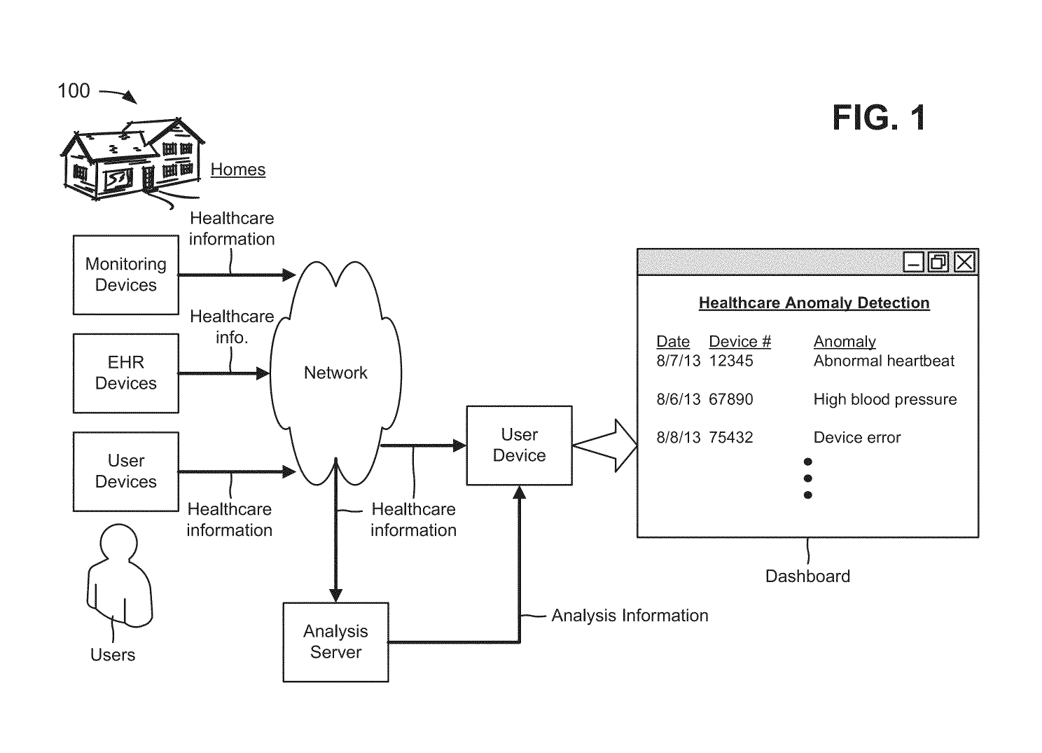

FIG. 1 is a diagram of an overview of an example implementation 100 described herein. In example implementation 100, assume that multiple monitoring devices (e.g., associated with home monitoring systems), multiple EHR devices, and/or multiple user devices are associated with a network. An EHR device may include a device that collects and stores healthcare information (e.g., EHRs) for users (e.g., patients) associated with healthcare providers. As further shown in FIG. 1, the monitoring devices, the EHR devices, and/or the user devices may generate healthcare information, and may utilize the network to provide the healthcare information to an analysis server and/or a user device associated with the analysis server. The healthcare information may include network data (e.g., information associated with usage, connectivity, provisioning, or the like of the network by/for the devices); device data (e.g., information associated with operation of the devices, models of the devices, or the like); and/or application data (e.g., discharge summaries, referral information, consultant reports, medication lists, test results, lab results, medication allergy lists, vital sign readings, or the like). In some implementations, an entity, such as a healthcare provider, may utilize the application data to monitor the healthcare information, detect precursors to adverse health events, alert appropriate medical personnel, or the like.

As further shown in FIG. 1, the analysis server may receive the healthcare information from the monitoring devices, the EHR devices, and/or the user devices. The analysis server may perform an analysis of the healthcare information, in near real time (e.g., real time or approximately real time), real time, or batch time, via anomaly detection, trending, prediction, segmentation, or the like. In some implementations, the analysis server may perform a particular analysis for healthcare information received from monitoring devices, EHR devices, and/or user devices associated with a particular entity. For example, certain devices may be associated with a particular user, and the analysis server may perform an analysis for healthcare information received from the certain devices. As further shown in FIG. 1, the analysis server may generate analysis information based on the analysis of the healthcare information, and may provide the analysis information, for display, to the user device.

In some implementations, the analysis server may enable an entity (e.g., users of the user devices, healthcare providers, or the like) to access or receive analysis information that is customized for the entity. For example, as shown in FIG. 1, the analysis server may provide, for display, a dashboard to the user device associated with the entity. The dashboard may include analysis information that is customized for the entity, such as information associated with anomalous readings received by devices of the entity (e.g., which may be indicative of a health problem associated with the entity). For example, as shown in FIG. 1, the dashboard may indicate that device number “12345” is receiving an abnormal heartbeat reading, that device number “67890” is receiving a high blood pressure reading, that device number “75432” is indicating a device error, or the like. Such information may enable the entity to identify health problems with one or more users that require follow up, and to address the identified health problems (e.g., by alerting the users and/or appropriate medical personnel). In some implementations, the healthcare information provided by the dashboard may be compliant with a particular standard (e.g., Health Insurance Portability and Accountability Act (HIPAA) regulations or the like).

Systems and/or methods described herein may provide a framework for monitoring and detecting anomalies in healthcare information. The systems and/or methods may enable users (e.g., patients), healthcare providers, or the like to detect precursors to adverse health events based on an analysis (e.g., anomaly detection, diagnosis, trending, prediction, segmentations, prognostics, or the like) of healthcare information generated by monitoring devices, EHR devices, and/or user devices. The systems and/or methods may provide alerts of the adverse health events to the users, the healthcare providers, or the like so that the users may appropriately address the adverse health events, which may significantly reduce costs for the users, the healthcare providers, or the like.

As used herein, the term user is intended to be broadly interpreted to include a user device, a monitoring device, or a user of a user device and/or a monitoring device. The term entity, as used herein, is intended to be broadly interpreted to include a business, an organization, a government agency, a healthcare provider, a user device, a user of a user device, or the like.

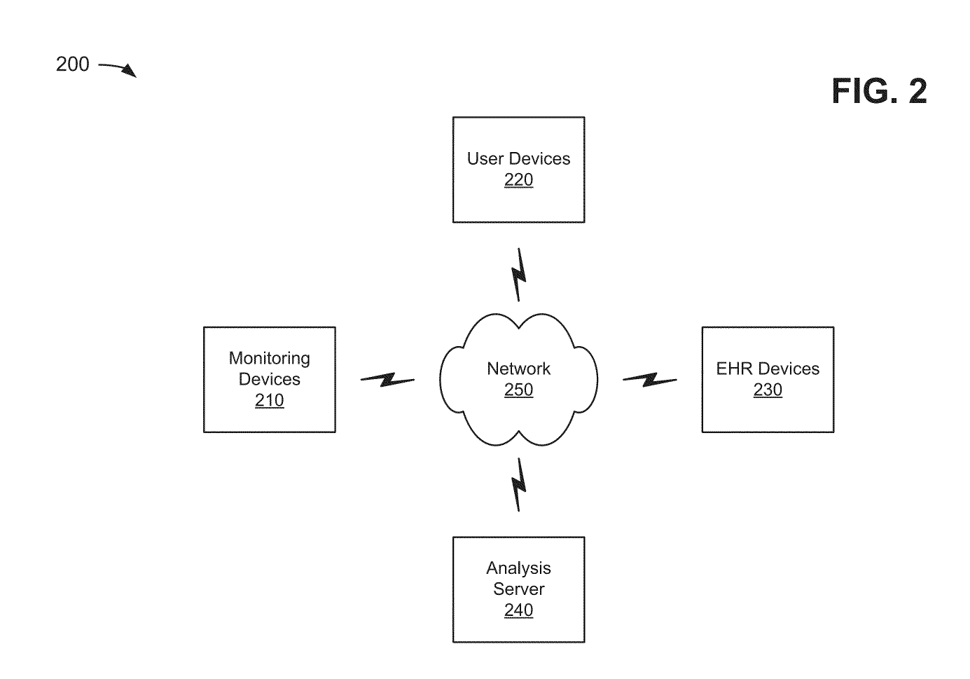

FIG. 2 is a diagram of an example environment 200 in which systems and/or methods, described herein, may be implemented. As illustrated, environment 200 may include monitoring devices 210 (referred to collectively as “monitoring devices 210,” and individually as “monitoring device 210”), user devices 220 (referred to collectively as “user devices 220,” and individually as “user device 220”), EHR devices 230 (referred to collectively as “EHR devices 230,” and individually as “EHR device 230”), an analysis server 240, and a network 250. Devices/networks of environment 200 may interconnect via wired connections, wireless connections, or a combination of wired and wireless connections.

Monitoring device 210 may include a device that is capable of monitoring a physical characteristic of a person, a condition associated with a person, or the like. In some implementations, monitoring device 210 may include a blood pressure monitor, a heart rate monitor, a scale, an electrocardiogram (ECG) monitor, a blood oxygen saturation level monitor, a pedometer, or the like. In some implementations, monitoring device 210 may wirelessly communicate over network 250 with user device 220 and/or analysis server 240.

User device 220 may include a device that is capable of communicating over network 250 with analysis server 220. In some implementations, user device 220 may include a radiotelephone; a personal communications services (PCS) terminal that may combine, for example, a cellular radiotelephone with data processing and data communications capabilities; a smart phone; a configured television; a laptop computer; a tablet computer; a global positioning system (GPS) device; a gaming device; a set-top box (STB); or another type of computation and communication device. In some implementations, user device 220 may include one or more monitoring devices 210 that monitor vital signs of a user, such as, for example, a heart rate monitor, an ECG monitor, a pedometer, or the like.

In some implementations, user device 220 associated with a particular user may receive device data (e.g., information associated with operation of monitoring devices 210, models of monitoring devices 210, error(s) generated by monitoring devices 210, or the like) from monitoring devices 210 associated with the particular user. In some implementations, user device 220 may receive application data (e.g., information output by monitoring devices 210 and/or EHR devices 230, such as, referral information, consultant reports, medication lists, test results, lab results, medication allergy lists, vital sign readings, or the like) from monitoring devices 210 and/or EHR devices 230 associated with the particular user.

In some implementations, the particular user may utilize the device data and/or the application data based on the type of device data and/or application data. For example, if the device data includes information indicating that monitoring device 210 is experiencing an error, the particular user may utilize the information to instruct a technician to check and correct monitoring device 210. In another example, if the application data includes information indicating that a blood pressure of the particular user is high, the particular user may utilize the information to consult a healthcare provider about the particular user's high blood pressure.

EHR device 230 may include one or more personal computers, one or more workstation computers, one or more server devices, one or more virtual machines (VMs) provided in a cloud computing environment, or one or more other types of computation and communication devices. In some implementations, EHR device 230 may include one or more data structures, such as databases, tables, lists, arrays, or the like. In some implementations, EHR device 230 may store information used to identify and/or authenticate users, healthcare information, information associated with particular regulations (e.g., HIPAA regulations), or the like. In some implementations, the information used to identify and/or authenticate users may include agreements (e.g., business associate agreements) entered into by the users with analysis server 240; license information (e.g., drivers license numbers, medical license numbers, or the like) associated with the users; demographic information (e.g., name, address, telephone number, age, or the like) associated with the users; or the like.

Analysis server 240 may include one or more personal computers, one or more workstation computers, one or more server devices, one or more VMs provided in a cloud computing environment, or one or more other types of computation and communication devices. In some implementations, analysis server 240 may be associated with an entity that manages and/or operates network 250, such as, for example, a telecommunication service provider, a television service provider, an Internet service provider, or the like.

In some implementations, analysis server 240 may receive the device data and the application data from monitoring devices 210, user devices 220, and/or EHR devices 230, and may receive network data (e.g., information associated with usage, connectivity, provisioning, or the like of network 250 by/for devices 210-230) from network 250. In some implementations, a device may be provided in network 250 to detect data (e.g., the device data, the application data, and/or the network data), and to provide the detected data to analysis server 240. Analysis server 240 may perform an analysis of the received data, in near real time, real time, or batch time, via anomaly detection, trending, prediction, segmentation, or the like. In some implementations, analysis server 240 may generate analysis information based on the analysis of the received data, and may provide the analysis information, for display, to user device 220. In some implementations, analysis server 240 may perform operations described herein in accordance with particular regulations (e.g., HIPAA regulations, privacy regulations, or the like).

Network 250 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a cloud computing network, or a combination of networks.

In some implementations, network 250 may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN). The EPC network may include an all-IP packet-switched core network that supports high-speed wireless and wireline broadband access technologies. The EPC network may allow monitoring devices 210 to access various services by connecting to the LTE network, an evolved high rate packet data (eHRPD) radio access network (RAN), and/or a wireless local area network (WLAN). The IMS network may include an architectural framework or network (e.g., a telecommunications network) for delivering IP multimedia services. The PDN may include a communications network that is based on packet switching.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

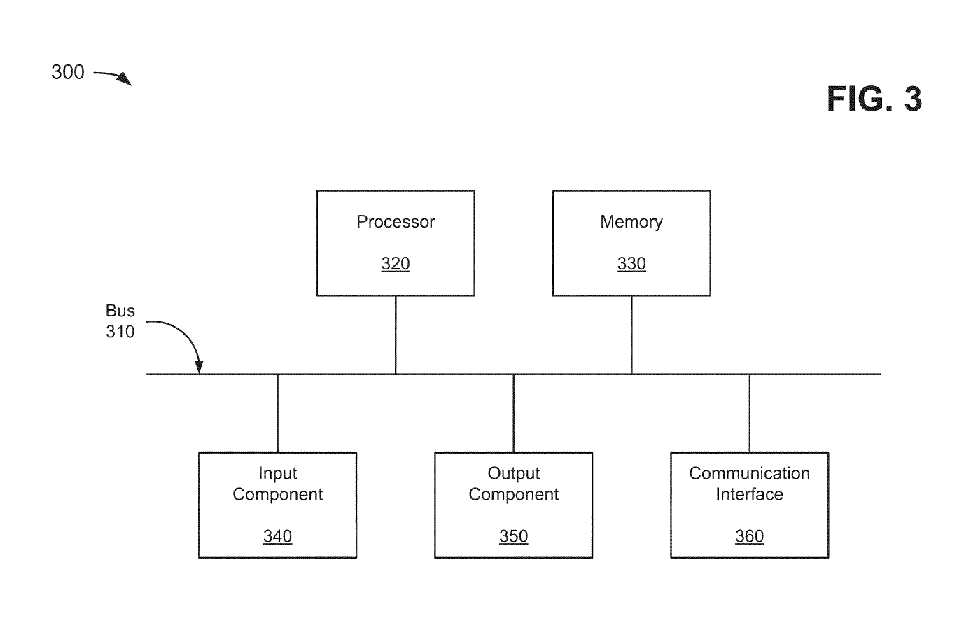

FIG. 3 is a diagram of example components of a device 300 that may correspond to one or more of the devices of environment 200. In some implementations, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, or the like), a microprocessor, and/or any processing component (e.g., a field-programmable gate array (FPGA), an application-specific integrated circuit (ASIC), or the like) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, or the like). Output component 350 may include a component that outputs information from device 300 (e.g., a display, a speaker, one or more light-emitting diodes (LEDs), or the like).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

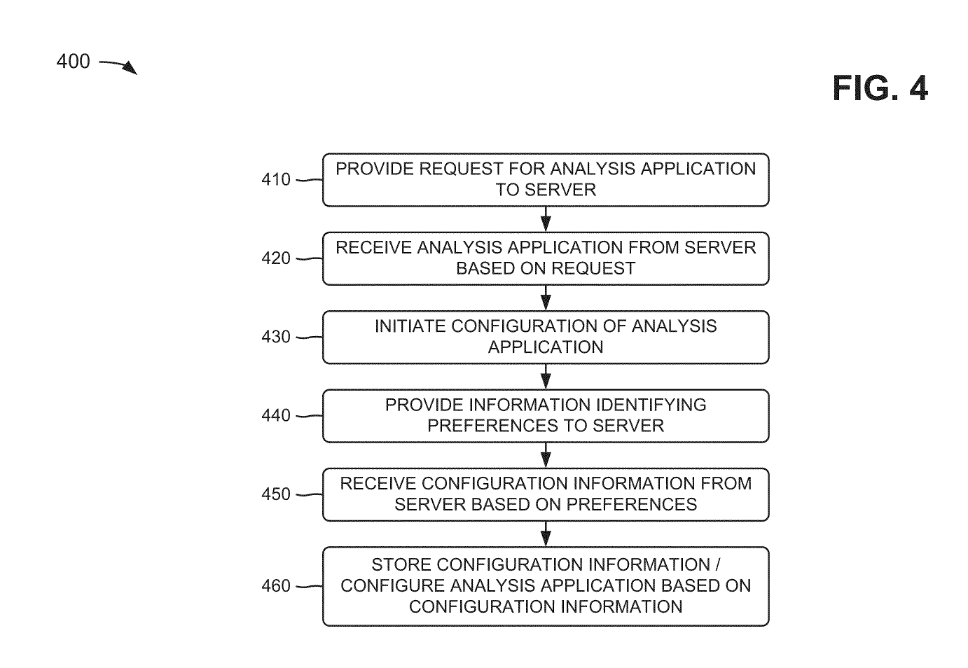

FIG. 4 is a flow chart of an example process 400 for receiving and configuring an analysis application for a user device. In some implementations, one or more process blocks of FIG. 4 may be performed by user device 220. In some implementations, one or more process blocks of FIG. 4 may be performed by another device or a group of devices separate from or including user device 220, such as analysis server 240.

As shown in FIG. 4, process 400 may include providing a request for an analysis application to a server (block 410). For example, a user may cause user device 220 to provide a request for an analysis application to analysis server 240. In some implementations, the analysis application may include an application, a code snippet, a script, a widget, or the like that causes user device 220 to perform one or more functions. For example, the analysis application may enable the user to set preferences for receiving information (e.g., device data, application data, network data, or the like), associated with monitoring devices 210 and/or EHR devices 230, that has been analyzed by analysis server 240. In some implementations, the user may cause user device 220 to access the analysis application via, for example, a user interface (such as a browser) provided by analysis server 240, or in another manner. The user may then select, using user device 220, information regarding the analysis application from the user interface to cause user device 220 to provide a request for the analysis application to analysis server 240. In some implementations, analysis server 240 may offer the analysis application to user device 220 without user device 220 providing the request for the analysis application.

As further shown in FIG. 4, process 400 may include receiving the analysis application from the server based on the request (block 420). For example, user device 220 may receive the analysis application from analysis server 240, and may store the analysis application in a memory associated with user device 220 (e.g., memory 330, FIG. 3). In some implementations, the user, of user device 220, may establish an account associated with the analysis application prior to or after receiving the analysis application. In some implementations, the analysis application may be stored in analysis server 240 (e.g., and not in user device 220), and user device 220 may access the analysis application via the user's account.

As further shown in FIG. 4, process 400 may include initiating a configuration of the analysis application (block 430). For example, the user may initiate the analysis application and identify, using user device 220, one or more preferences relating to receiving information associated with monitoring devices 210 and analyzed by analysis server 240. In some implementations, the user may identify the one or more preferences using one or more elements of a user interface provided by user device 220 and/or analysis server 240. The one or more elements may include, for example, one or more text input elements, one or more drop down menu elements, one or more checkbox elements, one or more radio button elements, and/or any other types of elements that may be used to receive information from the user.

Alternatively, or additionally, the one or more preferences may include a preference of the user with respect to the analysis application detecting anomalies associated with monitoring devices 210, user devices 220, EHR devices 230, and/or users associated with information provided by devices 210-230. For example, the analysis application may detect anomalies associated with usage, connectivity, provisioning, or the like of network 250 by/for devices 210-230, security associated with devices 210-230 (e.g., if monitoring device 210 has moved from a fixed location, this may indicate that monitoring device 210 has been stolen), application data generated by devices 210-230, or the like.

Alternatively, or additionally, the one or more preferences may include a preference of the user with respect to the analysis application providing trends and/or historical information associated with monitoring devices 210, user devices 220, EHR devices 230, and/or users associated with information provided by devices 210-230. For example, the analysis application may determine trends and/or store historical information associated with usage, connectivity, provisioning, or the like of network 250 by/for devices 210-230, security associated with devices 210-230, errors generated by devices 210-230, application data generated by devices 210-230, or the like.

Alternatively, or additionally, the one or more preferences may include a preference of the user with respect to the analysis application sending notifications associated with anomalies detected for devices 210-230 and/or users associated with information provided by devices 210-230. For example, the user may indicate that the analysis application is to send notifications to the user or to others associated with user device 220 (e.g., via a text message, an email message, a voicemail message, a voice call, or the like).

Alternatively, or additionally, the one or more preferences may include a preference of the user with respect to the analysis application providing a comparison of devices 210-230 with similar devices and/or a comparison of users with similar users. For example, the user may indicate that the analysis application is to provide a comparison of monitoring devices 210 (and/or users of monitoring devices 210) with other similar monitoring devices 210 (and/or other similar user), devices providing similar services as monitoring devices 210, or the like.

Alternatively, or additionally, the one or more preferences may include a preference of the user with respect to the analysis application providing miscellaneous information associated with devices 210-230 and/or users associated with information provided by devices 210-230. For example, the user may indicate that the analysis application is to correlate different types of data received from user devices 220, predict future behavior of monitoring devices 210 and/or users monitored by monitoring devices 210, or the like.

Alternatively, or additionally, a type of the account, of the user, associated with the analysis application may determine the quantity of preferences that the user is able to specify. For example, the analysis application may enable the user to specify only a portion of the above preferences or specify additional preferences based on the type of the account with which the user is associated.

As further shown in FIG. 4, process 400 may include providing information identifying one or more preferences to the server (block 440). For example, the user may cause user device 220 to provide, to analysis server 240, information identifying the one or more preferences relating to the user and provided during the configuration of the analysis application.

As further shown in FIG. 4, process 400 may include receiving configuration information from the server based on the preferences (block 450). For example, user device 220 may receive, from analysis server 240, configuration information that may be used to configure the analysis application to receive information associated with devices 210-230 and analyzed by analysis server 240.

In some implementations, analysis server 240 may generate the configuration information, which may be used to configure the analysis application, based on the information identifying the one or more preferences of the user. For example, the configuration information may include information that causes the analysis application to receive information associated with devices 210-230 and analyzed by analysis server 240.

Alternatively, or additionally, the configuration information may include information that causes analysis server 240 to detect anomalies associated with devices 210-230 and/or users associated with information provided by devices 210-230, and to provide information associated with the detected anomalies to user device 220. Alternatively, or additionally, the configuration information may include information that causes analysis server 240 to provide trends and/or historical information, associated with devices 210-230 and/or users associated with information provided by devices 210-230, to user device 220.

Alternatively, or additionally, the configuration information may include information that causes analysis server 240 to send notifications (e.g., to other users and devices other than user device 220) associated with anomalies detected by analysis server 240 for devices 210-230 and/or users associated with information provided by devices 210-230. Alternatively, or additionally, the configuration information may include information that causes analysis server 240 to perform a comparison of devices 210-230/users with similar devices/user, and to provide information associated with the comparison to user device 220. Alternatively, or additionally, the configuration information may include information that causes analysis server 240 to correlate different types of data received from devices 210-230, predict future behavior of devices 210-230 and/or users associated with information provided by devices 210-230, or the like, and to provide the correlation and/or behavior to user device 220.

Alternatively, or additionally, the configuration information may be obtained from a data structure. In some implementations, analysis server 240 may provide, to user device 220, the configuration information independent of receiving the information identifying the one or more preferences of the user.

As further shown in FIG. 4, process 400 may include storing the configuration information and configuring the analysis application based on the configuration information (block 460). For example, the user may cause user device 220 to store all or a portion of the configuration information received from analysis server 240. The analysis application may be configured based on storing all or a portion of the configuration information. In some implementations, analysis server 240 may store all or a portion of the configuration information.

In some implementations, analysis server 240 may provide updates, to the configuration information, to user device 220 based on use of the analysis application by user device 220 and/or by other user devices 220. For example, analysis server 240 may receive updates, to the configuration information, from one or more other users and may provide the received updates to user device 220. User device 220 may store the updates to the configuration information. In some implementations, analysis server 240 may provide the updates periodically based on a preference of the user and/or based on a time frequency determined by analysis server 240. In some implementations, analysis server 240 may determine whether to provide the updates based on the type of the account associated with the user.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

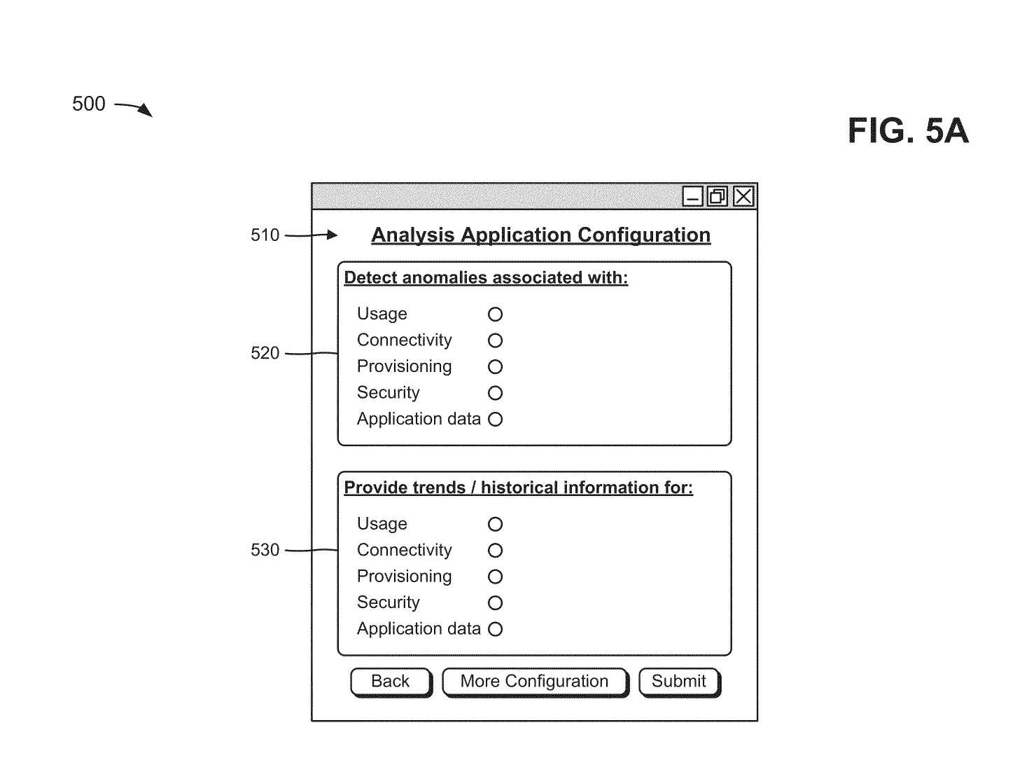

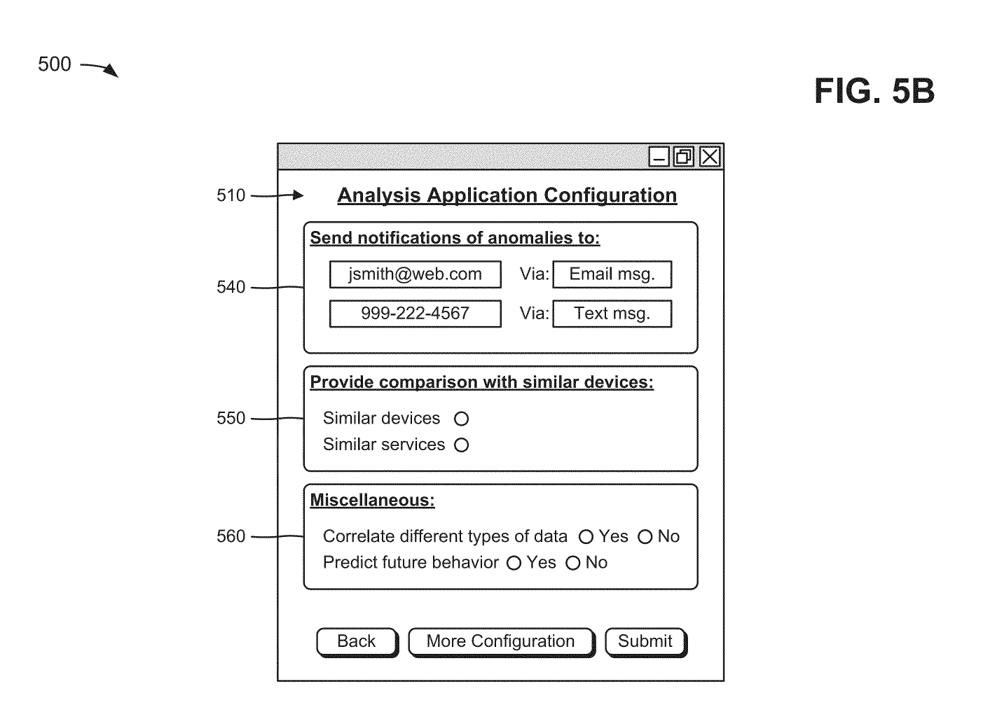

FIGS. 5A and 5B are diagrams 500 of example user interfaces that may be used in connection with example process 400 shown in FIG. 4. In some implementations, the user interfaces of FIGS. 5A and 5B may be provided by analysis server 240 to user device 220 to enable a user to identify information (e.g., preferences) that may be used to configure the analysis application so that user device 220 receives information associated with monitoring devices 210 and analyzed by analysis server 240.

Assume that the user has previously caused user device 220 to request and download the analysis application or to log into an account associated with the analysis application. Further assume that the user causes user device 220 to install the analysis application on user device 220. When the user logs into the account or user device 220 installs the analysis application, as shown in FIG. 5A, analysis server 240 may provide a user interface 510 to user device 220, and user device 220 may display user interface 510 to the user. User interface 510 may allow the user to configure different features of the analysis application. For example, the user may identify preferences for detecting anomalies associated with devices 210-230 and/or users associated with information provided by devices 210-230, in a first configuration section 520. In some implementations, the user may indicate that the user wants the analysis application to detect anomalies associated with usage of network 250 by devices 210-230. In some implementations, the user may indicate that the user wants the analysis application to detect anomalies associated with connectivity to network 250 by devices 210-230. In some implementations, the user may indicate that the user wants the analysis application to detect anomalies associated with provisioning of network 250 for devices 210-230. In some implementations, the user may indicate that the user wants the analysis application to detect anomalies associated with security of devices 210-230, application data generated by devices 210-230 (e.g., and relating to the users' health, such as anomalous heart rate, blood pressure, breathing, weight, or the like readings associated with the users), or the like.

As further shown in FIG. 5A, the user may identify preferences for providing trends and/or historical information, associated with devices 210-230 and/or users associated with information provided by devices 210-230, in a second configuration section 530. In some implementations, the user may indicate that the user wants the analysis application to provide trends and/or historical information associated with usage of network 250 by devices 210-230. In some implementations, the user may indicate that the user wants the analysis application to provide trends and/or historical information associated with connectivity to network 250 by devices 210-230. In some implementations, the user may indicate that the user wants the analysis application to provide trends and/or historical information associated with provisioning of network 250 for devices 210-230. In some implementations, the user may indicate that the user wants the analysis application to provide trends and/or historical information associated with security of devices 210-230, application data generated by devices 210-230 (e.g., trends and/or historical information for heart rate, blood pressure, breathing, weight, or the like readings associated with the users, or the like).

As shown in FIG. 5B, the user may identify preferences for sending notifications about anomalies, associated with devices 210-230 and/or users associated with information provided by devices 210-230, in a third configuration section 540. In some implementations, the user may indicate that the user wants the analysis application to provide a notification about the anomalies to one or more users associated with user device 220 and may indicate a notification method (e.g., send a notification to “jsmith@web.com” via an email message and send a notification to “999-222-4567” via a text message). In some implementations, the user may indicate that the user wants the analysis application to provide a notification about the anomalies to one or more other users.

As further shown in FIG. 5B, the user may identify preferences for providing a comparison, between devices 210-230/users and other devices/users, in a fourth configuration section 550. In some implementations, the user may indicate that the user wants the analysis application to provide a comparison between devices 210-230 and other similar devices 210-230. In some implementations, the user may indicate that the user wants the analysis application to provide a comparison between a characteristic of a first user and a characteristic of a second user. For example, the user may wish to compare information obtained from a first monitoring device 210 that monitors blood pressure of a first user with information obtained from a second monitoring device 210 that monitors blood pressure of a second user.

As further shown in FIG. 5B, the user may identify miscellaneous preferences for the analysis application in a fifth configuration section 560. In some implementations, the user may indicate that the user wants the analysis application to correlate different types of data (e.g., device data, application data, network data, or the like) associated with devices 210-230 and/or users associated with information provided by devices 210-230. In some implementations, the user may indicate that the user wants the analysis application to predict a future behavior (or condition) of devices 210-230 and/or users associated with information provided by devices 210-230 (e.g., based on the trends and/or the historical information).

Once the user has identified the preferences, user interface 510 may allow the user to select a “Submit” option to store the preferences and/or submit the preferences to analysis server 240. Analysis server 240 may then provide, to user device 220, configuration information based on the preferences.

As further shown in FIGS. 5A and 5B, user interface 510 may also allow the user to select a “Back” option to cause user device 220 to provide information regarding the analysis application. As also shown in FIGS. 5A and 5B, user interface 510 may also allow the user to select a “More Configuration” option to enable the user to identify additional information that may be used to configure the analysis application.

The number of elements of user interface 510 shown in FIGS. 5A and 5B is provided for explanatory purposes. In practice, user interface 510 may include additional elements, fewer elements, different elements, or differently arranged elements than those shown in FIGS. 5A and 5B.

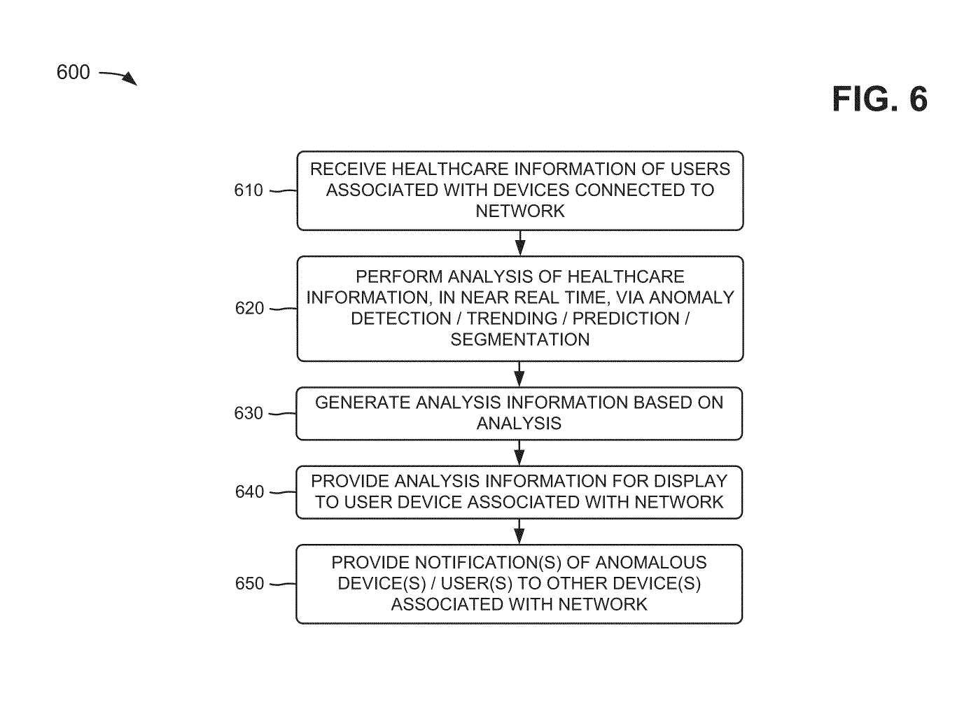

FIG. 6 is a flow chart of an example process 600 for monitoring and detecting anomalies in healthcare information. In some implementations, one or more process blocks of FIG. 6 may be performed by analysis server 240. In some implementations, one or more process blocks of FIG. 6 may be performed by another device or a group of devices separate from or including analysis server 240, such as user device 220.

As shown in FIG. 6, process 600 may include receiving healthcare information of users associated with devices connected to a network (block 610). For example, multiple monitoring devices 210, user devices 220, and/or EHR devices 230 may connect to network 250, and may be used to collect healthcare information associated with one or more users. In some implementations, analysis server 240 may monitor device data associated with devices 210-230, or devices 210-230 may provide the device data to analysis server 240. In some implementations, a device in network 250 may be configured to monitor and route the device data (or a copy of the device data) to analysis server 240. The device data may include, for example, information associated with components of devices 210-230, operation of devices 210-230, models of devices 210-230, errors generated by devices 210-230, or the like.

In some implementations, devices 210-230 may generate application data, and may provide the application data to user device 220 and/or analysis server 240. In some implementations, analysis server 240 may monitor the application data associated with devices 210-230. In some implementations, a device in network 250 may be configured to monitor and route the application data (or a copy of the application data) to analysis server 240. The application data may include, for example, data generated based on operation of devices 210-230 (e.g., blood pressure readings of users, heart rate readings of users, other vital sign readings of users, discharge summaries associated with users, referrals for users, consultant reports for users, medication lists of users, test results of users, lab results of users, procedures for users, tests for users, a medication allergy list of users, or the like).

In some implementations, network data may be generated by network devices of network 250 based on devices 210-230 utilizing network 250 to provide the device data and/or the application data to user device 220 and/or analysis server 240. In some implementations, analysis server 240 may monitor the network data associated with devices 210-230. In some implementations, a device in network 250 may be configured to monitor and route the network data (or a copy of the network data) to analysis server 240. The network data may include, for example, information associated with usage of network 250 by devices 210-230, connectivity of devices 210-230 to network 250, provisioning of network 250 for devices 210-230, or the like. In some implementations, the device data, the application data, and/or the network data may be referred to as healthcare information, and analysis server 240 may receive the healthcare information associated with devices 210-230.

In some implementations, analysis server 240 may preprocess the healthcare information utilizing feature selection (e.g., a process of selecting a subset of relevant features for use in model construction); dimensionality reduction (e.g., a process of reducing a number of random variables under consideration); normalization (e.g., adjusting values measured on different scales to a common scale); data subsetting (e.g., retrieving portions of data that are of interest for a specific purpose); or the like.

As further shown in FIG. 6, process 600 may include performing an analysis of the healthcare information, in near real time, real time, or batch time, via anomaly detection, trending, prediction, and/or segmentation (block 620). For example, analysis server 240 may perform an analysis of the healthcare information, in near real time, real time, or batch time, via analytics techniques, such as anomaly detection, trending, prediction, segregation, or the like. Performance of the analysis in real time may include analysis server 240 receiving the healthcare information, processing the healthcare information, and generating the analysis information so that the healthcare information may be utilized within a particular time (e.g., in milliseconds, microseconds, seconds, or the like) of receiving the healthcare information. Performance of the analysis in near real time may include the particular time associated with a real time analysis less a time required for analysis server 240 to generate the analysis information based on the healthcare information. In some implementations, analysis server 240 may perform an analysis of the healthcare information over time (e.g., not in near real time). In some implementations, analysis server 240 may utilize anomaly detection techniques to identify one or more anomalous devices 210-230 and/or users associated with information provided by devices 210-230, based on the healthcare information.

Anomaly detection may generally include identifying items, events, or observations that do not conform to an expected pattern or other items, events, or observations in a dataset. In some implementations, analysis server 240 may determine normal behavior patterns associated with devices 210-230 and/or users associated with information provided by devices 210-230, over time and based on the healthcare information. For example, analysis server 240 may determine that devices 210-230 have a particular usage pattern with network 250, that devices 210-230 have a particular connectivity pattern with network 250, that devices 210-230 generate particular application data, that particular users have high blood pressure, that particular users experience irregular breathing patterns, or the like.

Analysis server 240 may compare current healthcare information with the determined normal behavior patterns in order to detect anomalous devices 210-230/users and/or to predict abnormal behavior of devices 210-230/users before the abnormal behavior occurs (e.g., so that preventative action may be taken). In some implementations, analysis server 240 may utilize unsupervised anomaly detection techniques, supervised anomaly detection techniques, or semi-supervised anomaly detection techniques to identify one or more anomalous devices 210-230 and/or users associated with information provided by devices 210-230, based on the healthcare information. Anomaly detection may enable an entity (e.g., a doctor, a hospital, or the like) to identify potential health problems with particular users, and to appropriately address the potential health problems.

In some implementations, analysis server 240 may utilize trending techniques (or trend analysis) to determine trends in network usage, connectivity, and/or provisioning activities of devices 210-230; trends in the device data; and/or trends in the application data. Trending techniques may generally include collecting information and attempting to determine a pattern, or a trend, in the information. Trending techniques may be used to predict future events and/or to estimate uncertain events in the past. In some implementations, analysis server 240 may analyze the network usage, connectivity, and/or provisioning activities of devices 210-230, the device data, and/or the application data, for a particular time period, in order to identify the trends in the network usage, connectivity, and/or provisioning activities, the device data, and/or the application data. The trending technique may enable an entity (e.g., a doctor, a hospital, or the like) to predict when users will need healthcare services, and to schedule such services accordingly.

In some implementations, analysis server 240 may utilize prediction techniques (or predictive analytics) to determine future behavior of devices 210-230 and/or users associated with information provided by devices 210-230, based on historical healthcare information and/or correlated healthcare information (e.g., location information associated with devices 210-230, destination addresses of packets generated by devices 210-230, radio frequency (RF) data associated with devices 210-230 connections to network 250, or the like). Prediction techniques may generally include a variety of techniques (e.g., statistics, modeling, machine learning, data mining, or the like) that analyze current and historical information to make predictions about future, or otherwise unknown, events. In some implementations, analysis server 240 may determine normal behavior patterns associated with devices 210-230 and/or users associated with information provided by devices 210-230, over time and based on the healthcare information. Analysis server 240 may utilize the determined normal behavior patterns in order to predict future behavior of devices 210-230 (e.g., to predict future network usage, connectivity, and provisioning activities of devices 210-230) and/or users associated with information provided by devices 210-230. The prediction techniques may enable an entity (e.g., a doctor, a hospital, or the like) to predict when users will need healthcare services, and to schedule such services accordingly.

In some implementations, analysis server 240 may utilize segmentation techniques to determine groups of devices 210-230/users that are similar in behavior (e.g., different types of devices 210-230 may have similar network usage and connectivity behavior, similar users may have similar characteristics, conditions, or the like). Segmentation techniques may generally include dividing or clustering items into groups that are similar in specific ways relevant to the items, such as the behavior of the items. In some implementations, analysis server 240 may analyze the network usage, connectivity, and/or provisioning activities of devices 210-230, the device data, and/or the application data, for a particular time period, in order to identify similarities in the network usage, connectivity, and/or provisioning activities, the device data, and/or the application data associated with devices 210-230 and/or users associated with information provided by devices 210-230. Analysis server 240 may utilize the determined similarities to group devices 210-230 into groups of devices with similar behavior. In some implementations, analysis server 240 may analyze the network usage, connectivity, and/or provisioning activities of devices 210-230, the device data, and/or the application data, for a particular time period, in order to determine correlations between different types of data (e.g., between network usage data and the application data, between the network usage data and the network connectivity data, or the like). The segmentation technique may enable an entity (e.g., a healthcare provider) to compare similar users in order to determine when a particular user will need health services.

In some implementations, analysis server 240 may perform the analysis of the healthcare information via the anomaly detection techniques, the trending techniques, the prediction techniques, the segregation techniques, and/or other analytics techniques. In some implementations, a user of user device 220 may specify which analytics techniques to perform on the healthcare information. In some implementations, a number and types of analytics techniques performed by analysis server 240 on the healthcare information may be based on a type of account of the user, processing power of analysis server 240, an amount of money paid by the user, or the like.

As further shown in FIG. 6, process 600 may include generating analysis information based on the analysis of the healthcare information (block 630). For example, analysis server 240 may generate analysis information based on the analysis of the healthcare information (e.g., the device data, the application, and/or the network data) associated with devices 210-230 and/or users associated with information provided by devices 210-230. In some implementations, the analysis information may include information generated by performance of the anomaly detection techniques, the trending techniques, the prediction techniques, and/or the segmentation techniques by analysis server 240. In some implementations, analysis server 240 may store the analysis information in memory (e.g., memory 330, FIG. 3) associated with analysis server 240.

In some implementations, the analysis information may include a comparison of analyzed information, associated with devices 210-230 of a first user, and analyzed information, associated with devices 210-230 of a second user similar to the first user. Such implementations may enable an entity (e.g., a healthcare provider) to determine how the health of the first user compares with the health of the second user, and vice versa. In some implementations, analysis server 240 may process the analysis information by filtering patterns in the analysis information, performing visualization on the analysis information, interpreting patterns in the analysis information, or the like.

In some implementations, analysis server 240 may combine the results of the different analysis techniques (e.g., anomaly detection, trending, prediction, segregation, or the like) together to generate the analysis information. In some implementations, analysis server 240 may assign weights to different results of the different analysis techniques, and may combine the weighted results together to generate the analysis information. In some implementations, the analysis information may include information identifying anomalies in the application data (e.g., readings from particular devices 210-230 may be unusually high); information identifying anomalies in the device data (e.g., error codes may be generated by particular devices 210-230); information identifying anomalies in the network data (e.g., high data usage by particular devices 210-230); information identifying trends associated with the application data received from devices 210-230 (e.g., the application data may indicate that a user is experiencing increased blood pressure due to an increase in weight); information identifying comparisons between similar devices 210-230 and/or users (e.g., application data from a device 210-230 associated with a first user may be compared with application data from a device 210-230 associated with a second user); information identifying predictions for the users (e.g., devices 210-230 associated with a user may indicate that the user may need to have heart surgery in one year); or the like.

As further shown in FIG. 6, process 600 may include providing the analysis information for display to a user device associated with the network (block 640). For example, analysis server 240 may provide the analysis information, for display, to user device 220 associated with analysis server 240 and/or user devices 220 associated with users. In some implementations, analysis server 240 may generate a dashboard of user interfaces that include the analysis information, and may provide the dashboard to user device 220. In some implementations, the dashboard may include information identifying anomalous devices 210-230 and/or users; information identifying trends in the network data, the device data, and/or the application data associated with devices 210-230 and/or users; information identifying predicted future behavior (e.g., for the network data, the device data, and/or the application data) associated with devices 210-230 and/or users; information identifying groups of devices 210-230 and/or users that are similar in behavior; or the like.

In some implementations, the dashboard may include information that highlights problems with devices 210-230 (e.g., anomalous devices 210-230, devices 210-230 that are tampered with or stolen, problem usage trends associated with particular devices 210-230, or the like) and/or users associated with information provided by devices 210-230 (e.g., users that require health services, users that require surgery, users that require checkups, or the like). In such implementations, the dashboard may provide relevant predictive and diagnostic information, associated with devices 210-230 and/or users associated with information provided by devices 210-230, in a user interface. This may alert users about the problems with devices 210-230 and/or users associated with information provided by devices 210-230, so that the users may take appropriate actions to correct the problems.

In some implementations, the dashboard may aid an entity (e.g., a healthcare provider) in daily management of devices 210-230 and/or users associated with information provided by devices 210-230, and may enable the entity to make decisions associated with devices 210-230 and/or the users. In some implementations, the dashboard may enable the entity to control healthcare costs associated with devices 210-230 and/or the users by alerting the entity about problems with devices 210 and/or the users, by identifying network issues associated with devices 210-230, or the like. In some implementations, the dashboard may enable the entity to control asset losses and costs due to data security breaches. For example, the entity may determine that a device 210-230 is being stolen or tampered with if a location of device 210-230 changes, a connectivity pattern of device 210-230 changes, or the like. In another example, the entity may determine data security breaches based on packet inspection, by analysis server 240, of the application data received from devices 210-230 (e.g., with entity's permission). In some implementations, the dashboard may enable the entity to comply with legal regulations and/or to receive regulatory approval for devices 210-230. For example, the insight provided by the dashboard into the performance of devices 210-230 may help the entity receive approval (e.g., from regulatory agencies) for spending decisions associated with devices 210-230, and may also prevent legal liabilities associated with devices 210-230.

As further shown in FIG. 6, process 600 may include providing one or more notifications of anomalous device(s) and/or user(s) to other device(s) associated with the network (block 650). For example, analysis server 240 may provide one or more notifications, associated with one or more anomalous devices 210-230 and/or users, to other devices associated with an entity (e.g., a healthcare provider). In some implementations, the entity may designate one or more employees to receive the notifications from the analysis server 240 via a variety of notification methods (e.g., an email message, a text message, a telephone call, or the like). For example, if the entity designated Bob to receive the notification (e.g., via Bob's email address, “bob@website.com”) and Susan to receive the notification (e.g., via a text message to Susan's smart phone number “222-445-6788”), analysis server 240 may provide the notification to Bob via an email message to “bob@website.com,” and may provide the notification to Susan via a text message to “222-445-6788.”

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

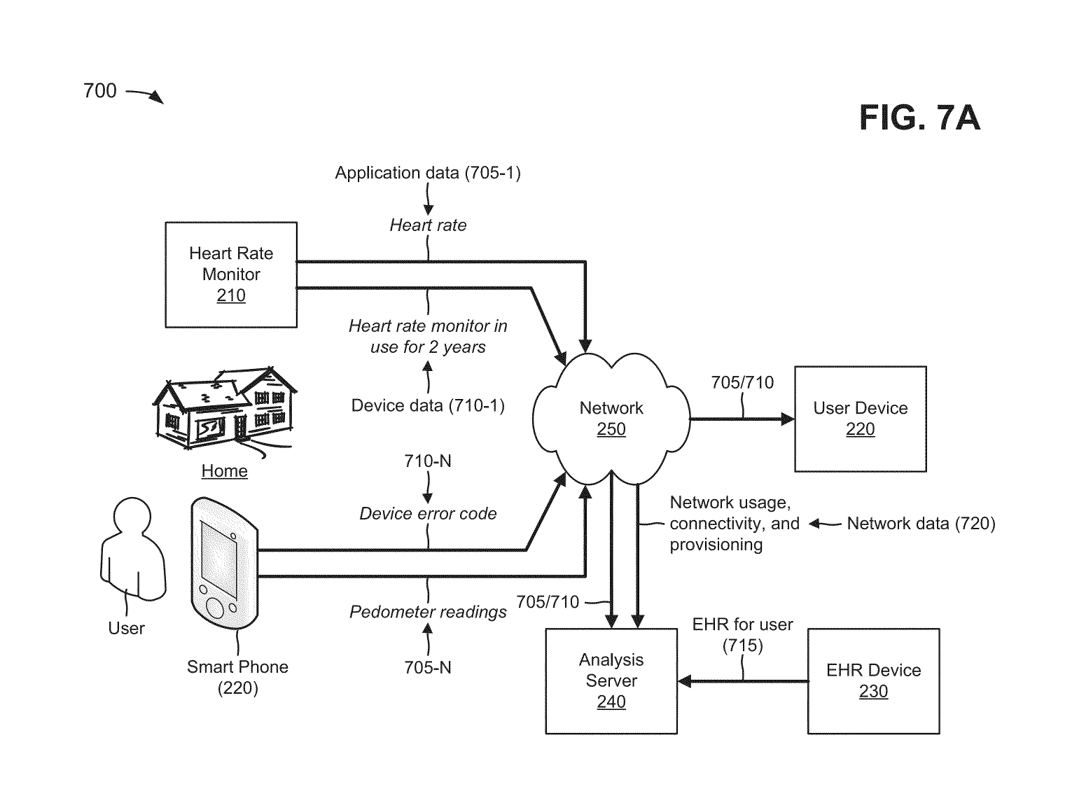

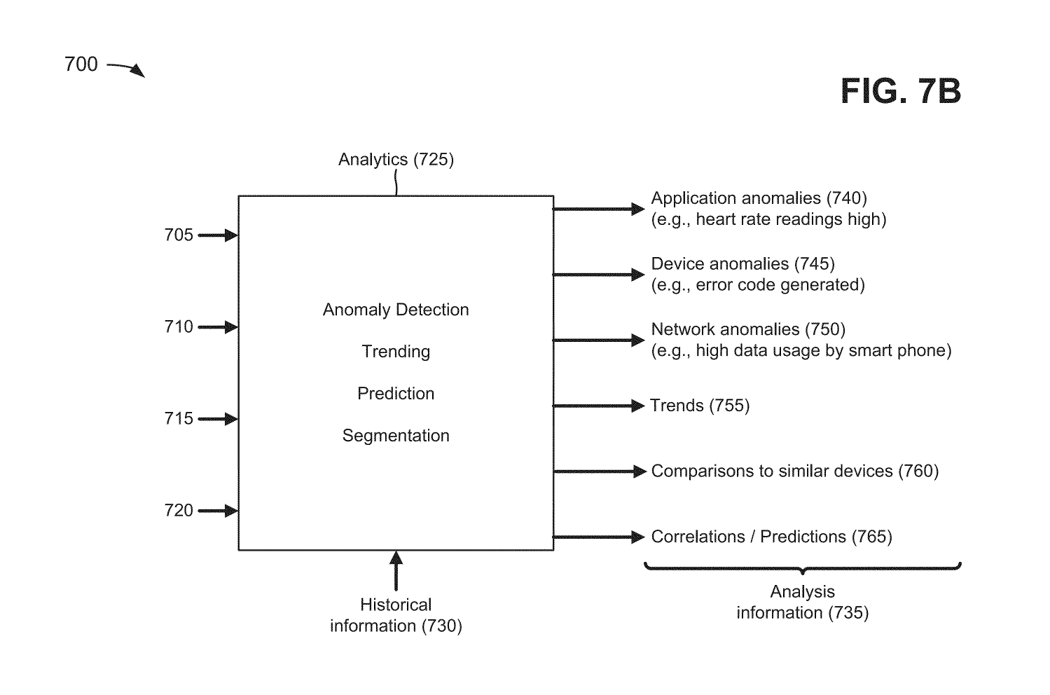

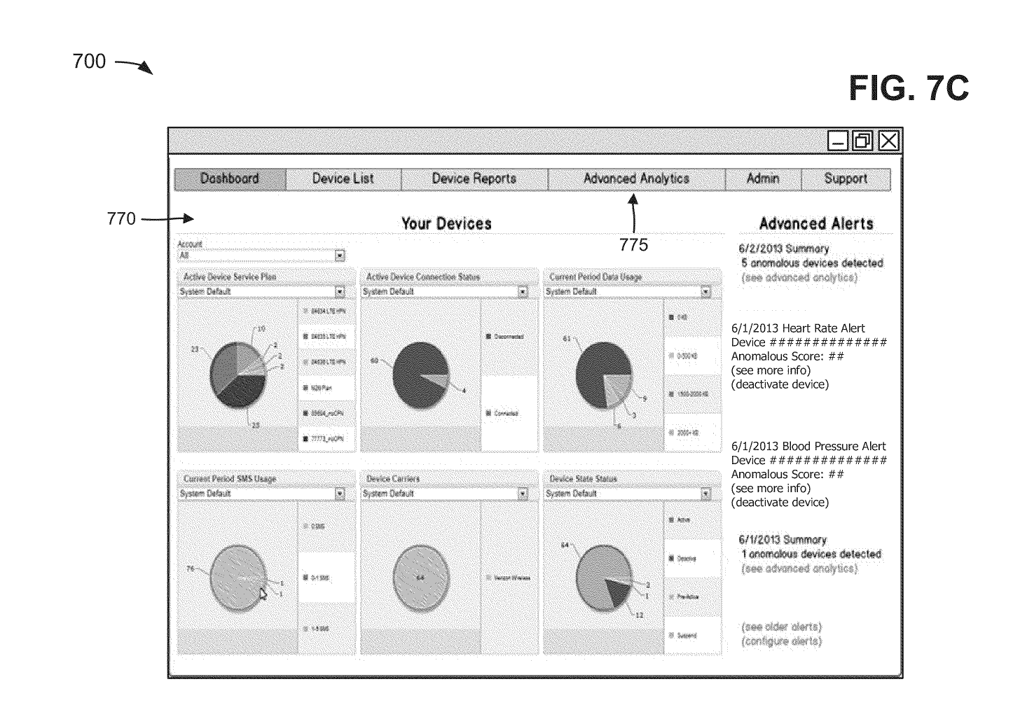

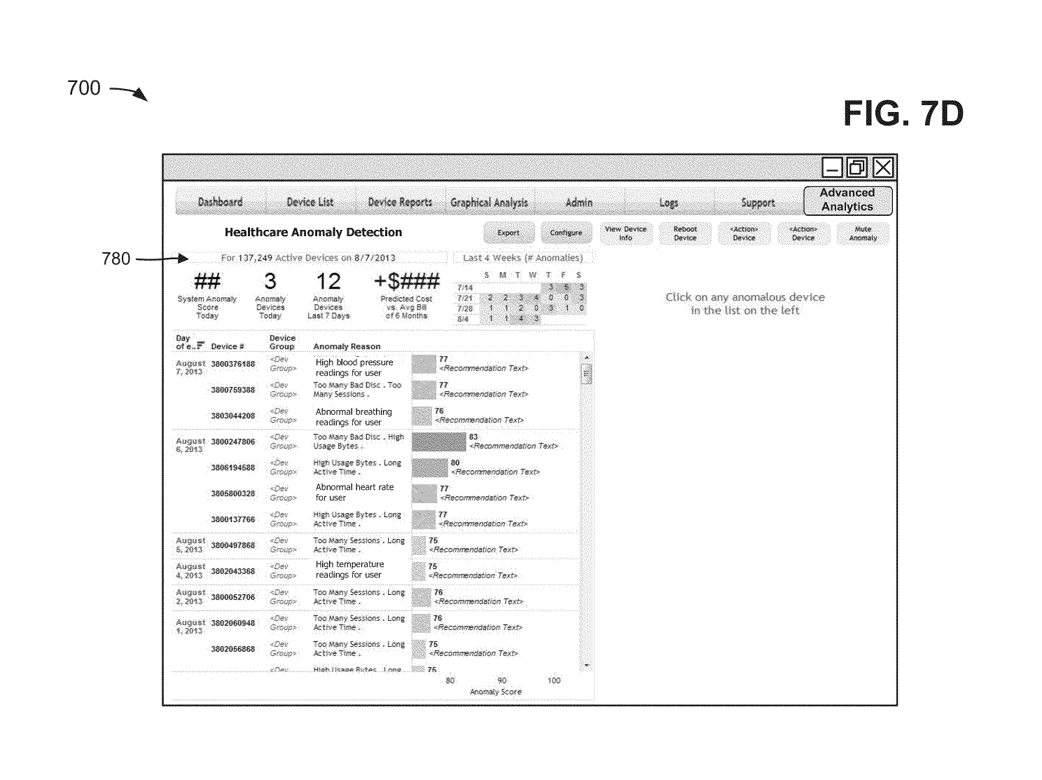

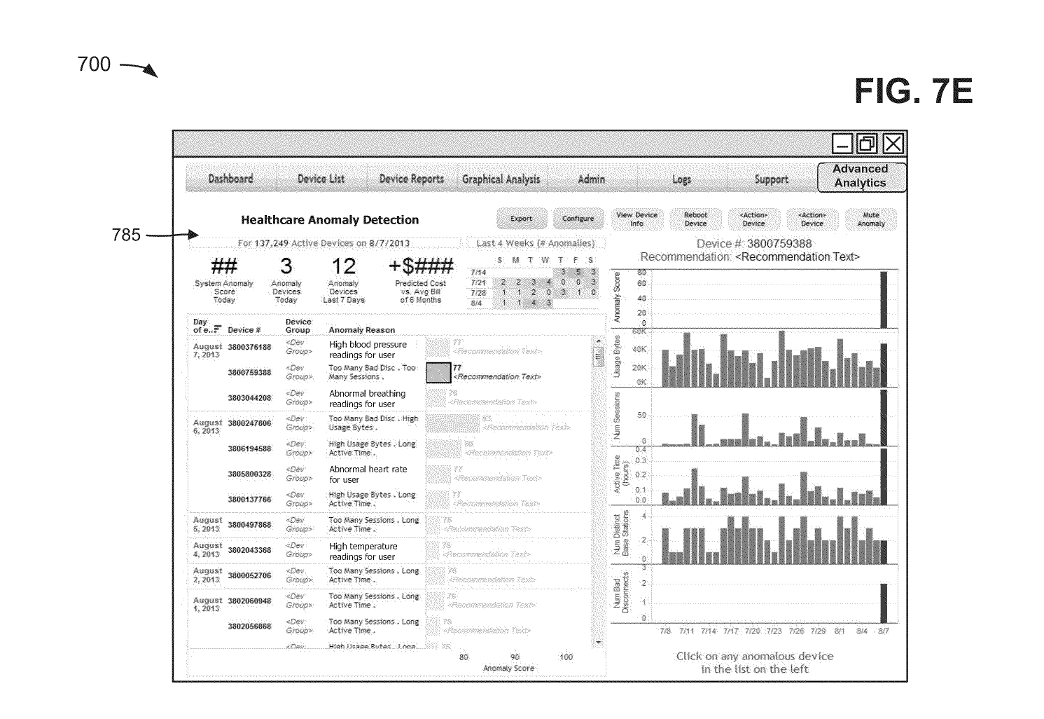

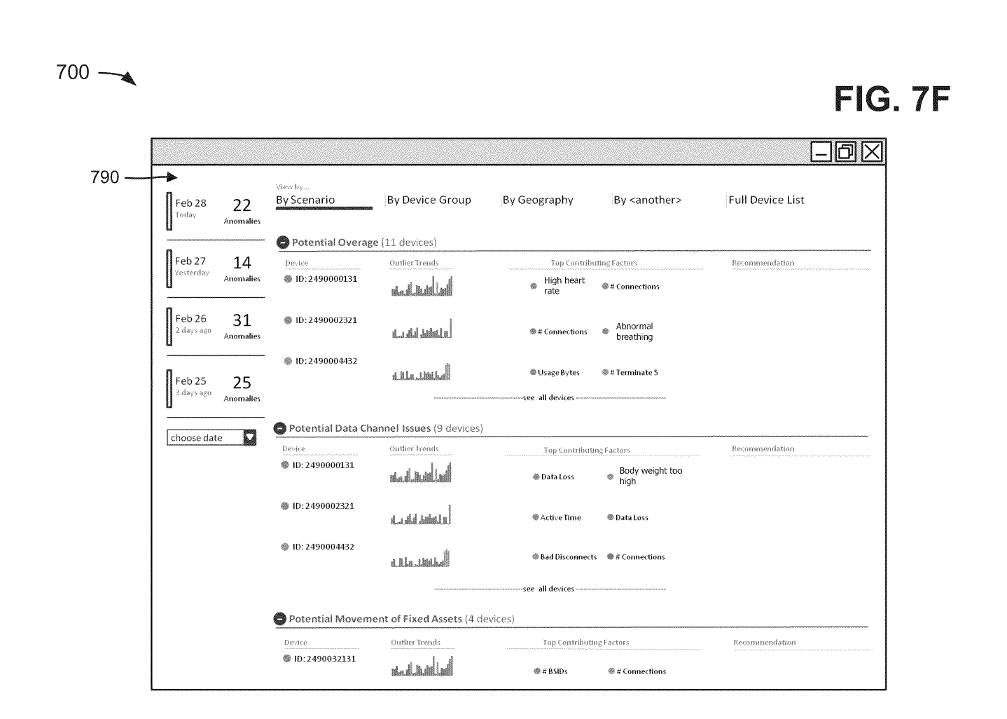

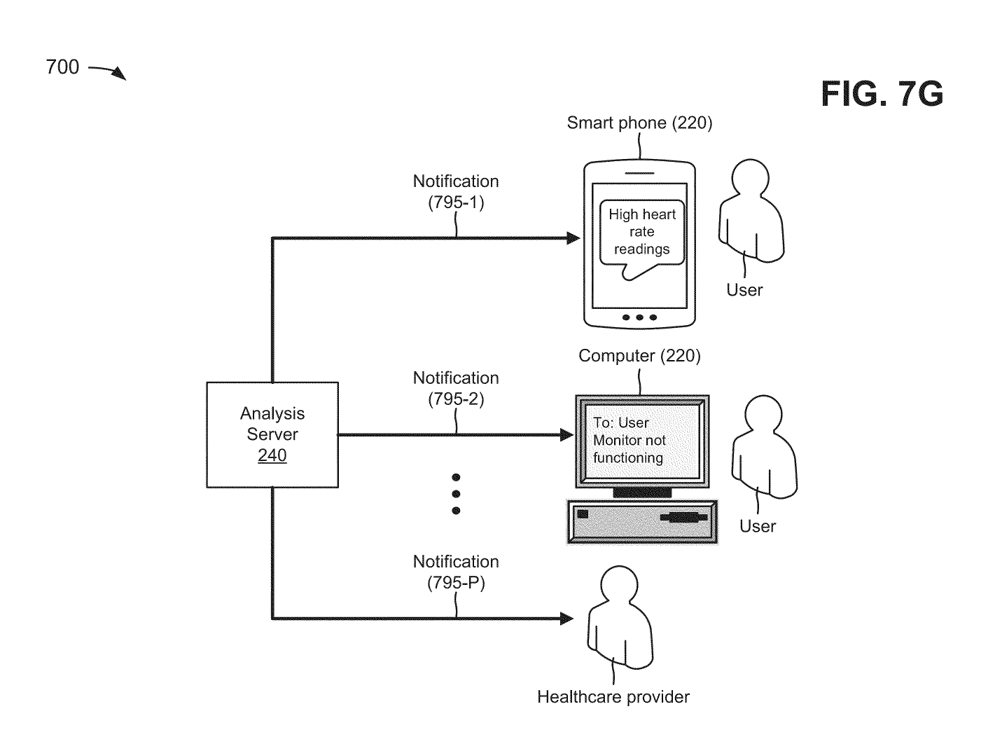

FIGS. 7A-7G are diagrams of an example 700 relating to example process 600 shown in FIG. 6. As shown in FIG. 7A, assume that multiple monitoring devices 210 (e.g., a heart rate monitor 210) and/or user devices 220 (e.g., a smart phone 220) are associated with a user and the user's home, and are managed and/or operated by a healthcare provider associated with user device 220. Heart rate monitor 210 may generate application data 705-1 (e.g., a heart rate of the user) based on operation of heart rate monitor 210, and may provide application data 705-1 to user device 220 and analysis server 240, via network 250. Smart phone 220 may generate application data 705-N (e.g., pedometer readings of the user, N≧1) based on operation of a pedometer provided in smart phone 210, and may provide application data 705-N to user device 220 and analysis server 240, via network 250. Other monitoring devices 210 and/or user devices 220, associated with the user, may generate application data 705, and may provide application data 705 to user device 220 and analysis server 240, via network 250.

As further shown in FIG. 7A, heart rate monitor 210 may generate device data 710-1 (e.g., indicating that heart rate monitor 210 has been in use for two years) based on operation of heart rate monitor 210, and may provide device data 710-1 to user device 220 and analysis server 240, via network 250. Smart phone 220 may generate device data 710-N (e.g., a device error code) based on operation of smart phone 220, and may provide device data 710-N to user device 220 and analysis server 240, via network 250. Other monitoring devices 210 and/or user devices 220, associated with the user, may generate device data 710, and may provide device data 710 to user device 220 and analysis server 240, via network 250.

As further shown in FIG. 7A, EHR device 230 may store an EHR 715 for the user, and may provide EHR 715 to analysis server 240. EHR 715 may include healthcare information associated with the user and collected by one or more healthcare providers. Furthermore, utilization of network 250 to provide application data 705 and device data 710 to user device 220 may generate network data 720, and network 250 may provide network data 720 to analysis server 240. Network data 720 may include usage of network 250 by monitoring devices 210 and/or user devices 220, information associated with connectivity of monitoring devices 210 and/or user devices 220 to network 250, information associated with provisioning of network 250 for monitoring devices 210 and/or user devices 220, or the like.

As shown in FIG. 7B, analysis server 240 may include an analytics component 720 that receives application data 705, device data 710, EHR 715, network data 720, and/or historical information 730 (e.g., historical application data 705, device data 710, EHRs 715, network data 720, or the like). Analytics component 720 may perform analytics techniques (e.g., anomaly detection, trending, prediction, segmentation, or the like) on application data 705, device data 710, EHR 715, network data 720, and/or historical information 730 to generate analysis information 735.

As further shown in FIG. 7B, analysis information 735 may include anomalies 740 associated with application data 705 (e.g., heart rate monitor 210 readings are high); anomalies 745 associated with device data 710 (e.g., error code generated by smart phone 220); anomalies 750 associated with network data 720 (e.g., high data usage of network 250 by smart phone 220); trends 755 associated with application data 705, device data 710, EHR 715, and/or network data 720; comparisons 760 of monitoring devices 210 and/or user devices 220 with similar devices (e.g., monitoring devices and/or user devices associated with another user); correlations and/or predictions 765 based on application data 705, device data 710, EHR 715, and/or network data 720; or the like. In some implementations, analysis information 735 may include network roaming patterns associated with devices 210-230, network usage (e.g., cell tower usage) heat maps associated with devices 210-230, analytics on fault tolerance (e.g., wireless backup) utilized by devices 210-230, results of deep packet inspection of application data 705, or the like.

Analysis server 240 may utilize analysis information 735 to generate a first dashboard user interface 770, as shown in FIG. 7C. Analysis server 240 may provide user interface 770, for display, to user device 220 so that the healthcare provider may review analysis information 735. As shown in FIG. 7C, user interface 770 may include information associated with devices 210-230 (e.g., Your Devices), such as service plans, connection status, data usage, short message service (SMS) usage, carrier information, state status, or the like associated with devices 210-230. User interface 770 may also include a section that displays alerts associated with particular devices 210-230 and/or users at particular times. For example, alert section may indicate that, on Jun. 2, 2013, five anomalous devices 210-230 were detected, and that, on Jun. 1, 2013, particular devices 210-230 detected a high heart rate and high blood pressure for the user. As further shown in FIG. 7C, user interface 770 may include an “Advanced Analytics” tab 775 that, when selected, may provide additional analysis information 735 for display.

Assume that “Advanced Analytics” tab 775 is selected, and that the selection causes analysis server 240 to provide a second dashboard user interface 780, for display, by user device 220, as shown in FIG. 7D. User interface 780 may include a first section that provides information associated with devices 210-230 and/or users on a particular day. For example, the first section may include information indicating that, on Aug. 7, 2013, the healthcare provider has “137,249” active devices 210-230; an anomaly score for the healthcare provider on Aug. 7, 2013; a number (e.g., three) of anomalous devices 210-230 detected on Aug. 7, 2013 (e.g., which may be indicative of anomalous users); a number (e.g., twelve) of anomalous devices 210-230 detected over the last seven days; a predicted cost for the healthcare provider for the next six months; or the like. In some implementations, the anomaly score may be calculated by analysis server 240 based on a number of anomalous devices 210-230 and/or users detected by analysis server 240 on Aug. 7, 2013; reasons associated with the anomalies detected for the anomalous devices 210-230; or the like.

As further shown in FIG. 7D, user interface 780 may include a second section that provides information associated with a number of anomalous devices 210-230 and/or users detected over the last four weeks (e.g., in a calendar format). User interface 780 may include a third section that provides detailed information associated with the anomalous devices 210-230 and/or users detected over a period of time. For example, the third section may include dates associated with when the anomalous devices 210-230 and/or users are detected (e.g., Aug. 7, 2013, Aug. 6, 2013, or the like); device numbers associated with the anomalous devices 210-230 (e.g., “3800376188,” “3800759388,” or the like); anomaly reasons associated with the anomalous devices 210-230 (e.g., high data usage, high blood pressure readings, abnormal breathing readings, abnormal heart rate readings, or the like); and/or graphs associated with the anomalous devices 210-230 and/or users.

If one of the anomalous devices 210-230 and/or users listed in the third section of user interface 780 is selected, analysis server 240 may provide a third dashboard user interface 785, for display, by user device 220, as shown in FIG. 7E. User interface 785 may include the first section, the second section, and the third section of user interface 780, and may include a fourth section that provides information associated with the selected anomalous device 210-230. For example, the fourth section may include information identifying an anomaly score, data usage, a number of sessions, an active time, a number of distinct base stations, a number of bad disconnects, or the like associated with the selected anomalous device 210-230. As further shown in FIG. 7E, user interface 785 may include mechanisms (e.g., tabs, icons, links, or the like) that enable the healthcare provider to return to user interface 770 (e.g., FIG. 7C), view a list of devices 210-230, view reports associated with devices 210-230, perform a graphical analysis of analysis information 735, export analysis information 735, configure one or more devices 210-230, view device data associated with a particular device 210-230, reboot a particular device 210-230, or the like.

As shown in FIG. 7F, analysis server 240 may provide a fourth dashboard user interface 790, for display, by user device 220. User interface 790 may include a section that provides a number of anomalies (e.g., anomalous devices 210-230 and/or users) detected on a particular day. For example, the section may indicate that, on February 28, twenty-two anomalous devices 210-230 were detected. User interface 790 may enable a user to view information associated with devices 210-230 based on scenario, device group, geography, or the like. For example, as shown in FIG. 7F, when the information associated devices 210-230 is viewed based on scenario, user interface 790 may include information associated with potential overages (e.g., by eleven devices 210-230), potential data channel issues (e.g., by nine devices 210-230), potential anomalous device readings for breathing, body weight, heart rate, etc., or the like.

As shown in FIG. 7G, analysis server 240 may generate notifications 795-1 through 795-P (P≧1) based on analysis information 735. For example, as shown in FIG. 7G, analysis server 240 may provide notification 795-1 to smart phone 220 associated with the user. Notification 795-1 may include a text message that indicates that heart rate readings are high for the user. Analysis server 240 may provide notification 795-2 to a computer 220 associated with the user or another user (e.g., an employee of the healthcare provider). Notification 795-2 may include an email message that indicates heart rate monitor 210 is not functioning properly. Analysis server 240 may provide notification 795-P for display to still another user (e.g., another employee of the healthcare provider). Notification 795-P may include information (e.g., provided via user interface 770, FIG. 7C) that indicates high heart rate readings for a particular monitoring device 210.

As indicated above, FIGS. 7A-7G are provided merely as an example. Other examples are possible and may differ from what was described with regard to FIGS. 7A-7G. In some implementations, the various operations described in connection with FIGS. 7A-7G may be performed automatically or at the request of a user.

Systems and/or methods described herein may provide a framework for monitoring and detecting anomalies in healthcare information. The systems and/or methods may enable users, healthcare providers, or the like to detect precursors to adverse health events based on an analysis of healthcare information generated by monitoring devices, EHR devices, and/or user devices. The systems and/or methods may provide alerts of the adverse health events to the users, the healthcare providers, or the like so that the users may appropriately address the adverse health events, which may significantly reduce costs for the users, the healthcare providers, or the like.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, or the like). The user interfaces may receive user inputs via one or more input devices, may be user-configurable (e.g., a user may change the sizes of the user interfaces, information displayed in the user interfaces, color schemes used by the user interfaces, positions of text, images, icons, windows, or the like, in the user interfaces, or the like), and/or may not be user-configurable. Information associated with the user interfaces may be selected and/or manipulated by a user (e.g., via a touch screen display, a mouse, a keyboard, a keypad, voice commands, or the like). In some implementations, information provided by the user interfaces may include textual information and/or an audible form of the textual information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, healthcare information associated with a plurality of users,
the healthcare information associated with the plurality of users including:
information associated with a health of the plurality of users, and
information associated with a plurality of monitoring devices that monitor the health of the plurality of users, or
information associated with network connectivity of the plurality of monitoring devices;
performing, by the device, an analysis of the healthcare information via one or more analytics techniques;
generating, by the device, analysis information based on the analysis of the healthcare information,
the analysis information identifying a potential issue with at least one of the plurality of users or at least one of the plurality of monitoring devices; and
providing, by the device, the analysis information for display.

2. The method of claim 1, further comprising:
providing one or more notifications associated with the analysis information to one or more other devices associated with the device.

3. The method of claim 2, where the one or more notifications include information associated with a particular user, of the plurality of users, identified as being anomalous based on the analysis of the healthcare information.

4. The method of claim 1, further comprising:
determining that a particular user, of the plurality of users, requires a particular health service based on the analysis information; and
providing, for display, information indicating that the particular user requires the particular health service.

5. The method of claim 1, where the one or more analytics techniques include two or more of:
an anomaly detection technique to identify at least one anomalous user, of the plurality of users, based on the healthcare information,
a trending technique to identify one or more trends for the plurality of users based on the healthcare information,
a prediction technique to predict one or more behaviors of the plurality of users based on the healthcare information, or
a segmentation technique to group the plurality of users, into groups, based on the healthcare information.

6. The method of claim 1, where the analysis information includes one or more of:
information associated with one or more anomalies identified in the information associated with the health of the plurality of users, the information associated with the plurality of monitoring devices, or the information associated with the network connectivity,
information associated with one or more trends identified in the information associated with the health of the plurality of users, the information associated with the plurality of monitoring devices, or the information associated with the network connectivity,
information associated with one or more comparisons of the information associated with the health of the plurality of users, the information associated with the plurality of monitoring devices, or the information associated with the network connectivity, or
information associated with one or more predictions determined based on the information associated with the health of the plurality of users, the information associated with the plurality of monitoring devices, or the information associated with the network connectivity.

7. The method of claim 1, where each of the plurality of monitoring devices includes one of:
a user device,
a blood pressure monitor,
a heart rate monitor,
a scale,
an electrocardiogram (ECG) monitor,
a blood oxygen saturation level monitor, or
a pedometer.

8. A device, comprising:
one or more processors to:
receive healthcare information associated with a user,
the healthcare information associated with the user including:
information associated with a health of the user, and
information associated with a plurality of monitoring devices that monitor the health of the user, or
information associated with network connectivity of the plurality of monitoring devices;
perform an analysis of the healthcare information associated with the user via one or more analytics techniques and in near real time;
generate analysis information based on the analysis of the healthcare information associated with the user;
store the analysis information; and
provide the analysis information for display.

9. The device of claim 8, where the one or more processors are further to:
provide a notification associated with the analysis information to at least one other device, associated with the device, via an email message, a text message, a voicemail message, or a voice call.

10. The device of claim 9, where the notification includes information, associated with the user, identified as being anomalous based on the analysis of the healthcare information associated with the user.

11. The device of claim 8, where the healthcare information further includes one or more of:
discharge information associated with the user,
a referral associated with the user,
a medication list for the user,
a test result for the user,
a lab result for the user,
a list of follow-up appointments for the user,
a medical procedure associated with the user, or
vital sign readings.

12. The device of claim 8, where the one or more analytics techniques include a plurality of:
an anomaly detection technique to identify anomalous information, associated with the user, based on the healthcare information,
a trending technique to identify a trend for the user based on the healthcare information,
a prediction technique to predict a behavior of the user based on the healthcare information, or
a segmentation technique to group the user into a group of users based on the healthcare information.

13. The device of claim 8, where the analysis information includes a plurality of:
information associated with one or more anomalies identified in the information associated with the health of the user, the information associated with the plurality of monitoring devices, or the information associated with the network connectivity,
information associated with one or more trends identified in the information associated with the health of the user, the information associated with the plurality of monitoring devices, or the information associated with the network connectivity,
information associated with one or more comparisons of the information associated with the health of the user, the information associated with the plurality of monitoring devices, or the information associated with the network connectivity, or
information associated with one or more predictions determined based on the information associated with the health of the user, the information associated with the plurality of monitoring devices, or the information associated with the network connectivity.

14. The device of claim 8, where, when providing the analysis information for display, the one or more processors are further to:
generate a dashboard user interface that visually depicts the analysis information, and
provide the dashboard user interface for display.

15. A computer-readable medium for storing instructions, the instructions comprising:
one or more instructions that, when executed by one or more processors of a device, cause the one or more processors to:
receive, in accordance with one or more particular standards, healthcare information associated with a plurality of users,
the healthcare information associated with the plurality of users including:
information received from monitoring devices associated with the plurality of users,
information received from user devices associated with the plurality of users, and
electronic health records associated with the plurality of users;
perform an analysis of the healthcare information associated with the plurality of users via one or more analytics techniques;
generate analysis information based on the analysis of the healthcare information associated with the plurality of users,
the analysis information identifying a potential issue with at least one of the users of the plurality of users; and
provide the analysis information for display.

16. The computer-readable medium of claim 15, where the one or more instructions, when executed by the one or more processors, further cause the one or more processors to:
provide one or more notifications associated with the analysis information to one or more other devices associated with the device.

17. The computer-readable medium of claim 16, where the one or more notifications include:
information associated with a particular user, of the plurality of users, identified as being anomalous based on the analysis of the healthcare information.

18. The computer-readable medium of claim 15, where the one or more instructions, when executed by the one or more processors, further cause the one or more processors to:
determine that at least one user, of the plurality of users, requires a particular health service based on the analysis information; and
provide, for display, information indicating that the at least one user requires the particular health service.

19. The computer-readable medium of claim 15, where the one or more analytics techniques include a plurality of:
an anomaly detection technique to identify at least one anomalous user, of the plurality of users, based on the healthcare information,
a trending technique to identify one or more trends for the plurality of users based on the healthcare information,
a prediction technique to predict one or more behaviors of the plurality of users based on the healthcare information, or
a segmentation technique to group the plurality of users, into groups, based on the healthcare information.

20. The computer-readable medium of claim 15, where the analysis information includes a plurality of:
information associated with one or more anomalies identified in the information received from the monitoring devices, the information received from the user devices, or the electronic health records,
information associated with one or more trends identified in the information received from the monitoring devices, the information received from the user devices, or the electronic health records,
information associated with one or more comparisons of the information received from the monitoring devices, the information received from the user devices, or the electronic health records, associated with the plurality of users, and information received from monitoring devices, information received from user devices, or electronic health records associated with one or more other users, or
information associated with one or more predictions determined based on the information received from the monitoring devices, the information received from the user devices, or the electronic health records.
